(19) United States
(12) Patent Application Publication
(10) Pub. No.: US 2004/0098744 A1
(43) Pub. Date: May 20, 2004

(54) Creation of a stereotypical profile via image based clustering

(75) Inventor: Srinivas Gutta, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/298,976

(22) Filed: Nov. 18, 2002

(51) Int. Cl. H04N 5/445

(52) U.S. Cl. 725/46; 725/39

(57) ABSTRACT

In order to recommend items of interest to a user, such as television program recommendations, before a viewing or purchase history of the user is sufficiently developed to generate accurate recommendations, third party viewing or purchase histories are processed to generate stereotype profiles that reflect the typical patterns of items selected by representative viewers. To avoid being limited by the vocabulary of descriptive information associated with viewed programs, image content and/or image content features (mean, standard deviation, entropy) are employed as a basis for evaluating the viewing histories, alone or in combination with the descriptive information. A user can select the most relevant stereotype(s) from the generated stereotype profiles and thereby initialize his or her profile with the items that are closest to his or her own interests, with greater accuracy since the program content is employed directly in generating the stereotype profiles.

### TECHNICAL FIELD OF THE INVENTION

The present invention is directed, in general, to generating suggestions or recommendations regarding content of interest, such as television programming and, more specifically, to techniques for recommending programs and other items of potential interest before the user's purchase or viewing history is sufficiently developed without requiring the user to manually complete a profile.

### BACKGROUND OF THE INVENTION

Systems employed in generating guides, or information regarding available options in connection with a particular activity, may produce suggestions or recommendations for the user. Examples of such systems include on-line shopping or information retrieval systems and systems for delivery of content, particularly entertainment content such as audio or video programs, games and the like. In the case of systems delivering entertainment content, automatic action may be triggered by the generation of a suggestion or recommendation, such as caching, during a period when the entertainment content is not being utilized by the user, at least a portion of available entertainment content for later presentation to the user.

As the number of channels available to television viewers has increased, along with the diversity of the programming content available on such channels, identifying television programs of potential interest for television viewers has become increasingly challenging. Electronic programming guides (EPGs) identify available television programs by, for example, title, time, date and channel, and facilitate identification of programs of potential interest by permitting the available television programs to be searched or sorted in accordance with personalized preferences.

A number of recommendation tools have been proposed or employed for recommending television programming or other items of potential interest. Television program recommendation tools, for example, apply viewer preferences to an electronic program guide to obtain a set of recommended programs that may be of interest to the specific viewer. The viewer preferences employed by such television recommendation tools are generally obtained by explicit techniques, such as prompting the user to rate various program attributes (title, genre, actor(s), director, channel, etc.), implicit techniques, such as tracking the viewing history for the specific viewer, or some combination of the two.

Within recommendation tools of the type described, initialization of a new viewer (user) profile (i.e., “cold start”) is problematic. Initialization by explicit means is very tedious, requiring the viewer to respond to detailed survey questions specifying their preferences at a coarse granularity level and typically without the benefit of context (i.e., while viewing program(s) having such attributes). Initialization by implicit means, while unobtrusive by observing and correlating viewing behaviors, require a long time to become accurate, and require at least a minimal amount of viewing history to even begin making recommendations.

There is, therefore, a need in the art for improving initialization of user profiles employed by drecommendation tools.

### SUMMARY OF THE INVENTION

To address the above-discussed deficiencies of the prior art, it is a primary object of the present invention to provide, for use in recommendation tools employed to recommend items of interest to a user, such as television program recommendations, a technique for providing meaningful recommendations before a viewing or purchase history of the user is sufficiently developed to generate accurate recommendations. Third party viewing or purchase histories are processed to generate stereotype profiles that reflect the typical patterns of items selected by representative viewers. To avoid being limited by the vocabulary of descriptive information associated with viewed programs, image content and/or image content features (mean, standard deviation, entropy) are employed as a basis for evaluating the viewing histories, alone or in combination with the descriptive information. A user can select the most relevant stereotype(s) from the generated stereotype profiles and thereby initialize his or her profile with the items that are closest to his or her own interests, with greater accuracy since the program content is employed directly in generating the stereotype profiles.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the detailed description of the invention below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a television program recommendation tool employing a user profile initialized according to one embodiment of the present invention;

FIG. 2 is a sample table from the program database within a television program recommendation tool employing a user profile initialized according to one embodiment of the present invention;

FIG. 3 is a high level flowchart illustrating an exemplary implementation of a stereotype profile process according to one embodiment of the present invention;

FIG. 4 a high level flow chart illustrating an exemplary implementation of a clustering routine according to one embodiment of the present invention;

FIG. 5 a high level flow chart illustrating an exemplary implementation of a mean computation routine according to one embodiment of the present invention;

FIG. 6 is a high level flow chart illustrating an exemplary implementation of a distance computation routine according to one embodiment of the present invention;

FIG. 7A illustrates a data set containing the number of occurrences of each channel feature value for classes employed in deriving stereotypical profiles according to one embodiment of the present invention;

FIG. 7B illustrates the distances between each feature value pair computed from the exemplary counts shown in FIG. 7A; and

FIG. 8 a high level flow chart illustrating an exemplary implementation of a process for determining when the stopping criteria for creating clusters has been satisfied according to one embodiment of the present invention.

### DETAILED DESCRIPTION OF THE INVENTION

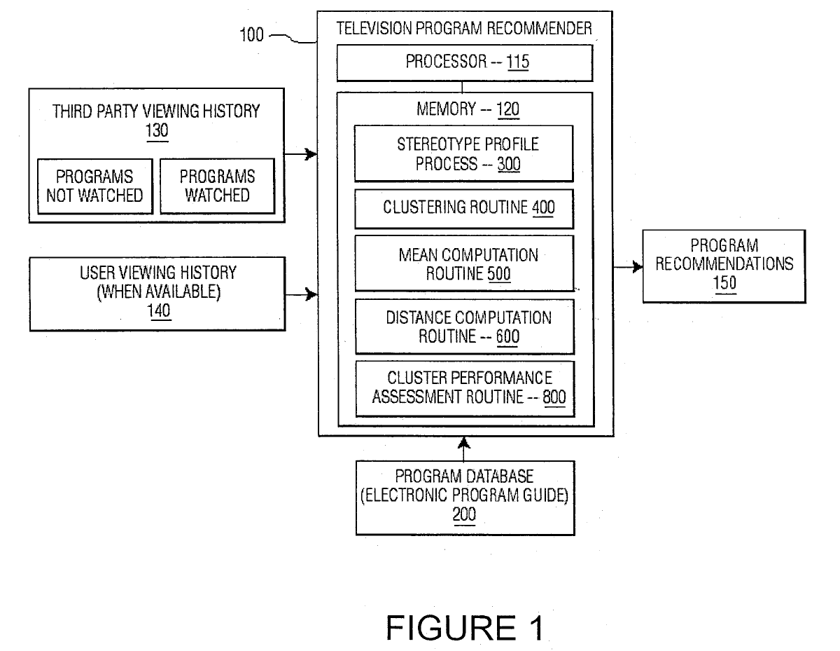

FIGS. 1 through 8, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a television program recommendation tool employing a user profile initialized according to one embodiment of the present invention. The exemplary television program recommendation tool may be hardware, software, or a combination thereof residing within a video recording device, a satellite, terrestrial, or cable television receiver, a combination receiver and recording device, or the like. Those skilled in the art will recognize that the full construction and operation of a suitable receiver and/or recording device is not depicted in the drawings or described herein. Instead, for simplicity and clarity, only so much of a receiver and/or recording device as is unique to the present invention or necessary for an understanding of the present invention is depicted and described herein. In addition, the principles described herein may be applied to other types of recommendation tools automatically generating recommendations based on an evaluation of user behavior (e.g., purchase history) for use in, for example, personal computers or set top boxes and the like.

In addition, recommendation tool 100 may be implemented in a distributed fashion, with portions of the functionality provided by one system and the results thereof transmitted to a second device for further processing or use.

Recommendation tool 100 evaluates programs within a program database 200 (such as an electronic program guide) to identify programs of potential interest to a specific viewer based on a user profile, which is at least partially initialized or updated implicitly. The set of recommended programs 101 is presented to the user on a display (not shown).

In the present invention, although the user profile is at least partially initialized or updated implicitly, recommendation tool 100 is capable of generating reasonably accurate program recommendations for a specific viewer before the viewing history 140 for that viewer is either available at all or sufficiently developed for accurate recommendation. Recommendation tool 100 initially employs a viewing history 130 or similar profile information for one or more third-party viewers to recommend programs of potential interest to a particular viewer. Generally, the third party viewing history 130 or user profile information is selected based on similarity of demographics (age, income, gender, education, etc.) between the specific viewer and one or more sample populations representative of a larger population.

As depicted in FIG. 1, third-party viewing history 130 includes a set of programs either watched or not watched by the corresponding sample population. The set of watched programs are identified by observing programs actually watched by the given sample population, while the set of not-watched programs are identified by, for instance, randomly sampling the programs within the program database 200 that were not watched by the sample population.

Recommendation tool 100 processes the third party viewing history 130 to generate stereotype profiles reflecting the typical viewing patterns of the representative sample population. A stereotype profile is a cluster of television programs (data points) that are similar to one another in some way. Thus, a given cluster or stereotype profile corresponds to a particular segment of television programs from the third party viewing history 130 exhibiting a specific pattern.

The third party viewing history 130 is processed in accordance with the present invention to provide clusters of programs exhibiting some specific pattern. Thereafter, a user can select the most relevant stereotype(s) based on corresponding demographic meta-data or preferences and thereby initialize his or her profile with the programs that are closest to his or her own interests. The stereotypical profile then adjusts and evolves towards the specific, personal viewing behavior of each individual user, depending on their viewing or recording patterns, and the feedback given to programs. In one embodiment, programs from the user's own viewing history 140 can be accorded a higher weight when determining a program score than programs from the third part viewing history 130.

The recommendation tool 100 may be embodied as any computing device, such as a personal computer or workstation, that contains a processor 115, such as a central processing unit (CPU), and memory 120, such as RAM and/or ROM. The television program recommendation tool 100 may also be embodied as an application specific integrated circuit (ASIC), for example, in a set-top terminal or display (not shown). In addition, the television programming recommendation tool 100 may be embodied as or within any available television program recommendation tool, such as the Tivo™ system, commercially available from Tivo, Inc., of Sunnyvale, Calif., or other the television program recommendation tools, modified to carry out the features and functions of the present invention.

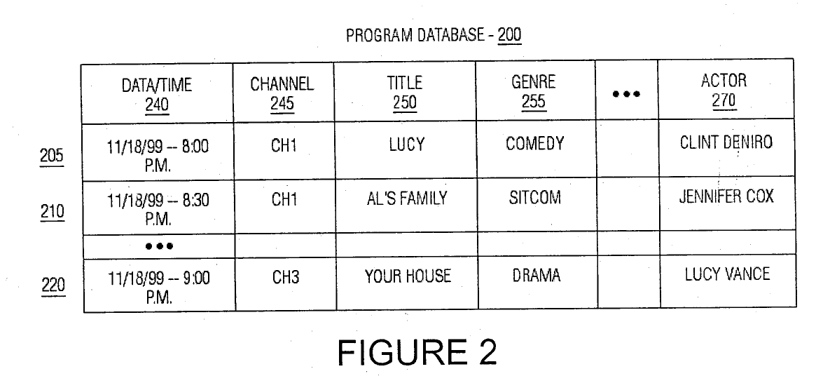

As shown in FIG. 1, and discussed further below in conjunction with FIGS. 2 through 8, the television programming recommendation tool 100 includes a program database 200, a stereotype profile process 300, a clustering routine 400, a mean computation routine 500, a distance computation routine 600 and a cluster performance assessment routine 800. Generally, the program database 200 may be embodied as a well-known electronic program guide and records or contains information for each program available in a given time interval. The stereotype profile process 300: (i) processes the third party viewing history 130 to generate stereotype profiles that reflect the typical patterns of television programs watched by representative viewers; (ii) allows a user to select the most relevant stereotype(s) and thereby initialize his or her profile; and (iii) generates recommendations based on the selected stereotypes.

The clustering routine 400 is called by the stereotype profile process 300 to partition the third party viewing history 130 (the data set) into clusters, such that points (television programs) in one cluster are closer to the mean (centroid) of that cluster than any other cluster. The clustering routine 400 calls the mean computation routine 500 to compute the symbolic mean of a cluster. The distance computation routine 600 is called by the clustering routine 400 to evaluate the closeness of a television program to each cluster based on the distance between a given television program and the mean of a given cluster. Finally, the clustering routine 400 calls a clustering performance assessment routine 800 to determine when the stopping or termination criteria for creating clusters is satisfied.

FIG. 2 is a sample table from the program database within a television program recommendation tool employing a user profile initialized according to one embodiment of the present invention, and comprises electronic program guide (EPG) 200 of FIG. 1 in the exemplary embodiment. As previously indicated, the program database 200 records information for each program that is available in a given time interval. As shown in FIG. 2, the program database 200 contains a plurality of records, such as records 205 through 220, each associated with a given program. For each program, the program database 200 indicates the date/time and channel (or channel call sign or network affiliation) associated with the program in fields 240 and 245, respectively.

The present invention attempts to build stereotypical profiles using symbolic information regarding the program. Symbolic information regarding program descriptive data such as genre, actor(s) , title, language (English, Spanish, French, etc.), program rating(s) (offensive language, sex, violence, nudity, etc.) and the like may be employed for this purpose. However, regardless of how sophisticated the technology employed to derive such stereotypical profiles (such as the clustering routines described in further detail below) from symbolic data based on program descriptive data, the overall performance in deriving accurate stereotypical profiles will be limited by the degree of richness and/or detail of the program descriptive data.

For instance, is some viewers enjoy cricket while others prefer shuttle or badminton, an expectation exists that the viewers enjoying cricket would be grouped together while the viewers preferring shuttle/badminton would be separately grouped together. However, such grouping is not possible unless the program descriptive data includes a category within which either cricket or shuttle/badminton may be separately specified. As a result, all viewers that enjoy cricket, shuttle/badminton, or both with be grouped together.

In the present invention, appropriate grouping of users in deriving stereotypical profile(s) is facilitated by employing symbolic data directly relating to the show's content rather than indirectly through the program's descriptive data. Therefore, the show's image content (or at least symbolic data representative thereof) is identified in one or more fields 250 through 270. The image content stored or represented may be one or more of: extracted image features for program frames (either frames for the entire program or for selected program “clips”) such as mean, standard deviation, entropy, etc.; key frames from the program or selected clip(s), or trailers or advertisements regarding the program. The key frames, trailers or advertisements may be either stored/represented directly or employed to derive extracted mean, standard deviation, or entropy program image features as described above.

Optionally program descriptive information such as title, genre, actors and/or rating(s) (offensive language, sex, violence, nudity, etc.) for each program, or symbolic information representative thereof, is also identified in fields 250 through 270. Additional well-known features (not shown), such as duration of the program, can also be included or represented in the program database 200.

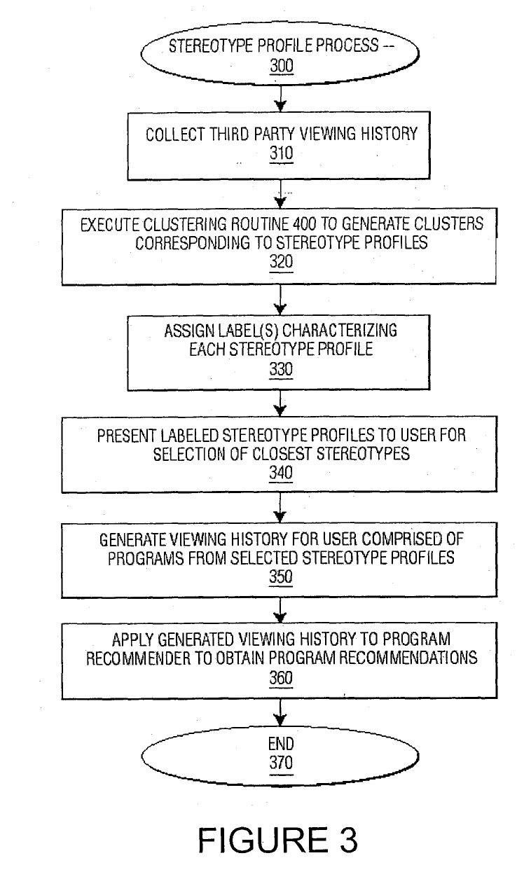

FIG. 3 is a high level flowchart illustrating an exemplary implementation of a stereotype profile process according to one embodiment of the present invention. As previously indicated, the stereotype profile process 300 (i) processes the third party viewing history 130 to generate stereotype profiles that reflect the typical patterns of television programs watched by representative viewers; (ii) allows a user to select the most relevant stereotype(s) and thereby initialize his or her profile; and (iii) generates recommendations based on the selected stereotypes. The processing of the third party viewing history 130 may be performed off-line in, for example, a research facility, and the television programming recommendation tool 100 can be provided to users installed with the generated stereotype profiles for selection by the users.

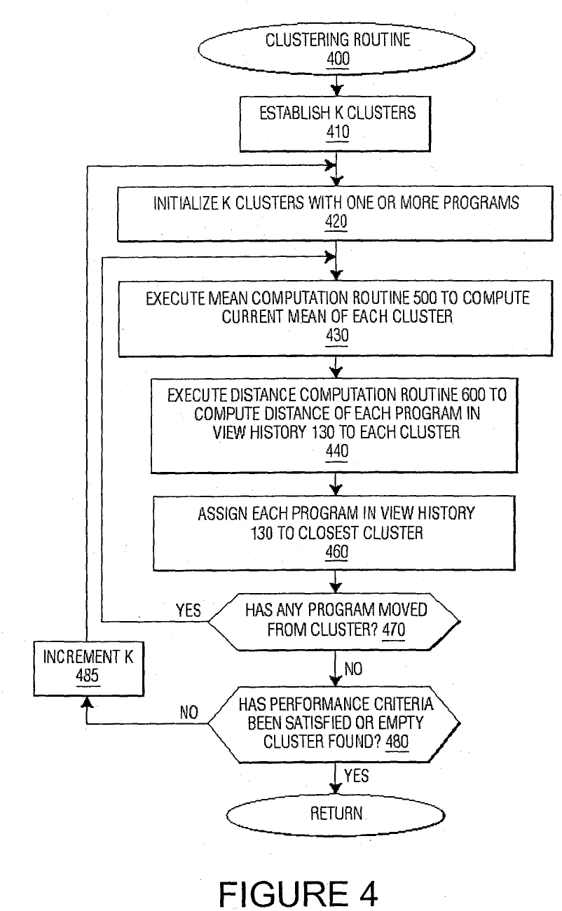

Thus, as shown in FIG. 3, the stereotype profile process 300 initially collects the third party viewing history 130 during step 310. Thereafter, the stereotype profile process 300 executes the clustering routine 400, discussed below in conjunction with FIG. 4, during step 320 to generate clusters of programs corresponding to stereotype profiles. As discussed further below, the exemplary clustering routine 400 may employ an unsupervised data clustering algorithm, such as a “k-means” cluster routine, to the view and process history data set 130. As previously indicated, the clustering routine 400 partitions the third party viewing history 130 (the data set) into clusters, such that points (television programs) in one cluster are closer to the mean (centroid) of that cluster than any other cluster.

The stereotype profile process 300 then assigns one or more label(s) to each cluster during step 330 that characterize each stereotype profile. In one exemplary embodiment, the mean of the cluster becomes the representative television program for the entire cluster and features of the mean program can be used to label the cluster. For example, the television programming recommendation tool 100 can be configured such that the genre is the dominant or defining feature for each cluster.

The labeled stereotype profiles are presented to each user during step 340 for selection of the stereotype profile(s) that are closest to the user's interests. The programs that make up each selected cluster can be thought of as the “typical view history” of that stereotype and can be used to build a stereotypical profile for each cluster. Thus, a viewing history is generated for the user during step 350 comprised of the programs from the selected stereotype profiles. Finally, the viewing history generated in the previous step is applied to a program recommendation tool during step 360 to obtain program recommendations. The program recommendation tool may be embodied as any conventional program recommendation tool, such as those referenced above, as modified herein, as would be apparent to a person of ordinary skill in the art. Program control terminates during step 370.

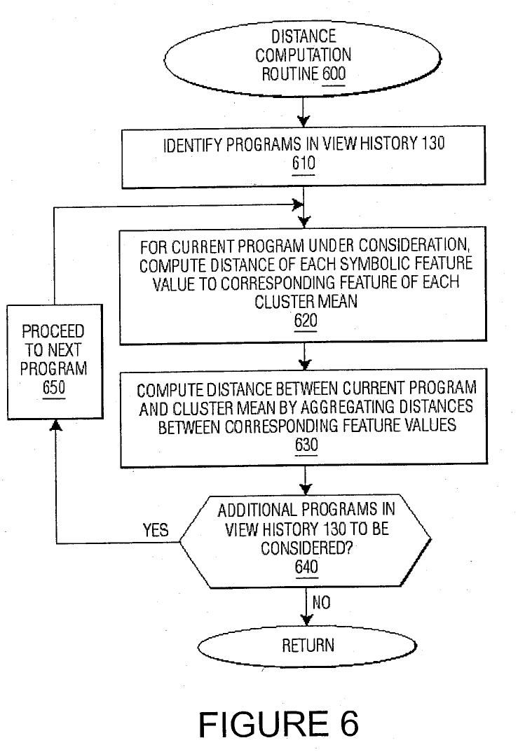

FIG. 4 is a flow chart describing an exemplary implementation of a clustering routine 400 incorporating features of the present invention. As previously indicated, the clustering routine 400 is called by the stereotype profile process 300 during step 320 to partition the third party viewing history 130 (the data set) into clusters, such that points (television programs) in one cluster are closer to the mean (centroid) of that cluster than any other cluster. Generally, clustering routines focus on the unsupervised task of finding groupings of examples in a sample data set. The present invention partitions a data set into k clusters using a k-means clustering algorithm. As discussed hereinafter, the two main parameters to the clustering routine 400 are (i) the distance metric of the symbolic data for each program attribute utilized for finding the closest cluster for a particular viewing history, discussed below in conjunction with FIG. 6; and (ii) k, the number of clusters to create.

The exemplary clustering routine 400 employs a dynamic value of k, with the condition that a stable k has been reached when further clustering of example data does not yield any improvement in the classification accuracy. In addition, the cluster size is incremented to the point where an empty cluster is recorded. Thus, clustering stops when a natural level of clusters has been reached.

As shown in FIG. 4, the clustering routine 400 initially establishes k clusters during step 410. The exemplary clustering routine 400 starts by choosing a minimum number of clusters, say two. For this fixed number, the clustering routine 400 processes the entire view history data set 130 to place each viewing history in one or both clusters and, over several iterations, arrives at two clusters which can be considered stable (i.e., no programs would move from one cluster to another, even if the algorithm were to go through another iteration). The current k clusters are initialized during step 420 with one or more programs.

In one exemplary implementation, the clusters are initialized during step 420 with some seed programs selected from the third party viewing history 130. The program for initializing the clusters may be selected randomly or sequentially. In a sequential implementation, the clusters may be initialized with programs starting with the first program in the view history 130 or with programs starting at a random point in the view history 130. In yet another variation, the number of programs that initialize each cluster may also be varied. Finally, the clusters may be initialized with one or more “hypothetical” programs that are comprised of feature values randomly selected from the programs in the third party viewing history 130.

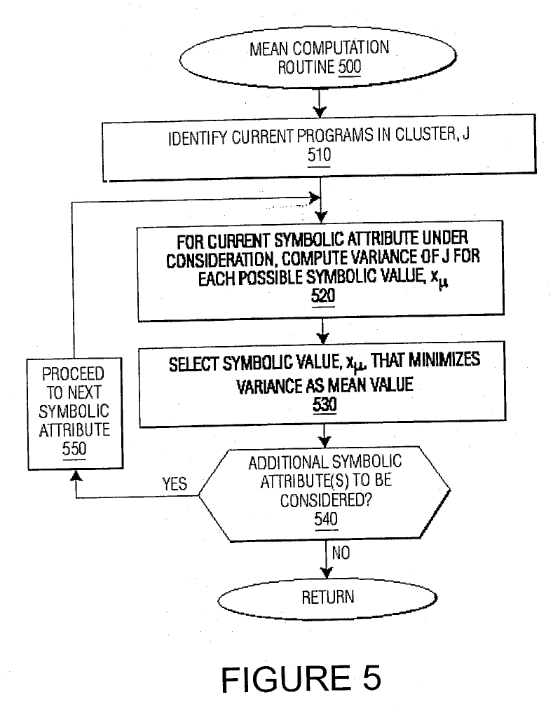

Thereafter, the clustering routine 400 initiates the mean computation routine 500, discussed below in conjunction with FIG. 5, during step 430 to compute the current mean of each cluster. The clustering routine 400 then executes the distance computation routine 600, discussed below in conjunction with FIG. 6, during step 440 to determine the distance of each program in the third party viewing history 130 to each cluster. Each program in the viewing history 130 is then assigned during step 460 to the closest cluster.

A test is performed during step 470 to determine if any program has moved from one cluster to another. If it is determined during step 470 that a program has moved from one cluster to another, then program control returns to step 430 and continues in the manner described above until a stable set of clusters is identified. If, however, it is determined during step 470 that no program has moved from one cluster to another, then program control proceeds to step 480.

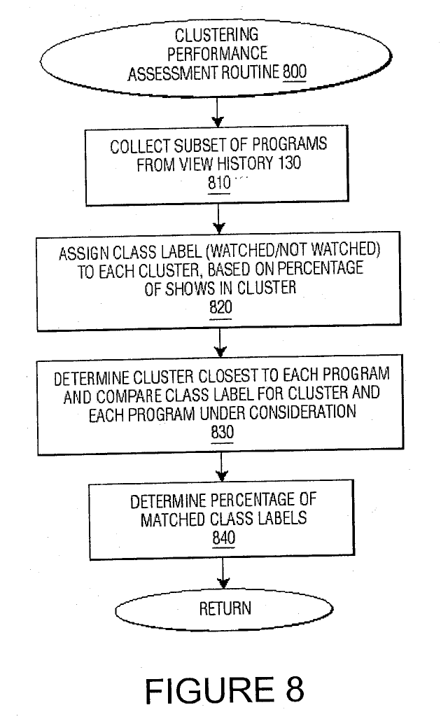

A further test is performed during step 480 to determine if a specified performance criteria has been satisfied or if an empty cluster is identified (collectively, the “stopping criteria”). If it is determined during step 480 that the stopping criteria has not been satisfied, then the value of k is incremented during step 485 and program control returns to step 420 and continues in the manner described above. If, however, it is determined during step 480 that the stopping criteria has been satisfied, then program control terminates. The evaluation of the stopping criteria is discussed further below in conjunction with FIG. 8.

The exemplary clustering routine 400 places programs in only one cluster, thus creating what are called crisp clusters. A further variation would employ fuzzy clustering, which allows for a particular example (television program) to belong partially to many clusters. In the fuzzy clustering method, a television program is assigned a weight, which represents how close a television program is to the cluster mean. The weight can be dependent on the inverse square of the distance of the television program from the cluster mean. The sum of all cluster weights associated with a single television program has to add up to 100%.

FIG. 5 is a flow chart describing an exemplary implementation of a mean computation routine 500 incorporating features of the present invention. As previously indicated, the mean computation routine 500 is called by the clustering routine 400 to compute the symbolic mean of a cluster. For numerical data, the mean is the value that minimizes the variance. Extending the concept to symbolic data, the mean of a cluster can be defined by finding the value of x_{μ} that minimizes intra-cluster variance Var(J):

$$Var ( J ) = {\sum }_{i ∈ J} {( {x}_{i} - {x}_{μ} )}^{2} \qquad ( 1 )$$

and the cluster radius (or the extent of the cluster):

R(J)=\sqrt{Var(J)} (2)

where J is a cluster of television programs from the same class (watched or not-watched), xᵢ is a symbolic feature value for show i, and x_{μ} is a feature value from one of the television programs in J such that Var(J) is minimized.

Thus, as shown in FIG. 5, the mean computation routine 500 initially identifies the programs currently in a given cluster, J, during step 510. For the current symbolic attribute under consideration, the variance of the cluster, J, is computed using equation (1) during step 520 for each possible symbolic value, x_{μ}. The symbolic value, x_{μ}, which minimizes the variance is selected as the mean value during step 530.

A test is performed during step 540 to determine if there are additional symbolic attributes to be considered. If it is determined during step 540 that there are additional symbolic attributes to be considered, then program control returns to step 520 and continues in the manner described above. If, however, it is determined during step 540 that there are no additional symbolic attributes to be considered, then program control returns to the clustering routine 400.

Computationally, each symbolic feature value in J is tried as x_{μ} and the symbolic value that minimizes the variance becomes the mean for the symbolic attribute under consideration in cluster J. There are two types of mean computation that are possible, namely, show-based mean and feature-based mean. The exemplary mean computation routine 500 discussed herein is feature-based, where the resultant cluster mean is made up of feature values drawn from the examples (programs) in the cluster, J, because the mean for symbolic attributes must be one of its possible values.

It is important to note that the cluster mean, however, may be a “hypothetical” television program. The feature values of this hypothetical program could include an image feature or descriptive data item value drawn from one of the key frames or examples (say, EBC) and the image feature or title value drawn from another of the examples (say, BBC World News, which, in reality never airs on EBC). Thus, any feature value that exhibits the minimum variance is selected to represent the mean of that feature. The mean computation routine 500 is repeated for all image and descriptive feature positions, until the process determines during step 540 that all features (i.e., symbolic attributes) have been considered. The resulting hypothetical program thus obtained is used to represent the mean of the cluster.

In a further variation, in equation (1) for the variance, xᵢ could be the image features and/or program descriptive data for the television program i itself and similarly x_{μ} is the program(s) in cluster J that minimize the variance over the set of programs in the cluster, J. In this case, the distance between the programs and not the individual feature values is the relevant metric to be minimized. In addition, the resulting mean in this case is not a hypothetical program, but is a program picked right from the set J. Any program thus found in the cluster, J, that minimizes the variance over all programs in the cluster, J, is used to represent the mean of the cluster.

The exemplary mean computation routine 500 discussed above characterizes the mean of a cluster using a single feature value for each possible feature (whether in a feature-based or program-based implementation) . It has been found, however, the relying on only one feature value for each feature during the mean computation often leads to improper clustering, as the mean is no longer a representative cluster center for the cluster. In other words, it may not be desirable to represent a cluster by only one program, but rather, multiple programs the represent the mean or multiple means may be employed to represent the cluster. Thus, in a further variation, a cluster may be represented by multiple means or multiple feature values for each possible feature. Thus, the N features (for feature-based symbolic mean) or N programs (for program-based symbolic mean) that minimize the variance are selected during step 530, where N is the number of programs used to represent the mean of a cluster.

As previously indicated, the distance computation routine 600 is called by the clustering routine 400 to evaluate the closeness of a specific television program to each cluster based on the distance between a given television program and the mean of a given cluster. The computed distance metric quantifies the distinction between the various examples in a sample data set to decide on the extent of a cluster. To be able to cluster user profiles, the distances between any two television programs in view histories must be computed. Generally, television programs that are close to one another tend to fall into one cluster. A number of relatively straightforward techniques exist to compute distances between numerical valued vectors, such as Euclidean distance, Manhattan distance, and Mahalanobis distance.

Existing distance computation techniques cannot be used in the case of television program vectors, however, because television programs are comprised primarily of symbolic feature values. For example, two television programs such as an episode of “Fiends” that aired on EBC at 7 p.m. on Oct. 22, 2002, and an episode of “The Simpsons” that aired on FEX at 8 p.m. on Oct. 25, 2002, can be represented using the following feature vectors:

| | |
|---|---|
| Image feature(s): XXX | Image feature(s): YYY |
| Title: Fiends | Title: Simons |
| Channel: EBC | Channel: FEX |
| Air-date: 2002 Oct. 22 | Air-date: 2002 Oct. 25 |
| Air-time: 2000 | Air-time: 2000 |

Clearly, known numerical distance metrics cannot be used to compute the distance between the image feature values “XXX” and “YYY” or descriptive feature values “EBC” and “FEX.” A Value Difference Metric (VDM) is an existing technique for measuring the distance between values of features in symbolic feature valued domains. VDM techniques take into account the overall similarity of classification of all instances for each possible value of each feature. Using this method, a matrix defining the distance between all values of a feature is derived statistically, based on the examples in the training set. For a more detailed discussion of VDM techniques for computing the distance between symbolic feature values, see, for example, Stanfill and Waltz, “Toward Memory-Based Reasoning,” Communications of the ACM, 29:12, 1213-1228 (1986).

The present invention employs VDM techniques or a variation thereof to compute the distance between feature values between two television programs or other items of interest. The original VDM proposal employs a weight term in the distance computation between two feature values, which makes the distance metric non-symmetric. A Modified VDM (MVDM) omits the weight term to make the distance matrix symmetric. For a more detailed discussion of MVDM techniques for computing the distance between symbolic feature values, see, for example, Cost and Salzberg, “A Weighted Nearest Neighbor Algorithm For Learning With Symbolic Features,” Machine Learning, Vol. 10, 57-58, Boston, Mass., Kluwer Publishers (1993).

According to MVDM, the distance, δ, between two values, V1 and V2, for a specific feature is given by:

$$δ ( V1 , V2 ) = \sum {\vert \frac{C1 i}{C1} - \frac{C2 i}{C2} \vert}^{r} \qquad ( 3 )$$

In the program recommendation environment of the present invention, this MVDM equation (3) is transformed to deal specifically with the classes “watched” and not-watched”:

$$δ ( V1 , V2 ) = \vert \frac{C1 {i}_{watched}}{{C1}_{watched}} - \frac{C2 {i}_{watched}}{{C2}_{watched}} \vert + \vert \frac{C1 {i}_{not\_watched}}{{C1}_{not\_watched}} - \frac{C2 {i}_{not\_watched}}{{C2}_{not\_watched}} \vert \qquad ( 4 )$$

In equation (4), V1 and V2 are two possible values for the feature under consideration. Continuing the above example, the first value or value set, V1, equals “XXX” (or “XXX” and “EBC”) and the second value or value set, V2, equals “YYY” (or “YYY” and “FEX”) for the feature “channel.” The distance between the values is a sum over all classes into which the examples are classified. The relevant classes for the exemplary program recommendation tool embodiment of the present invention are “Watched” and “Not-Watched.” C1i is the number of times V1 (XXX) was classified into class i (i equal to one (1) implies class Watched) and C1 (C1ₜₒₜₐₗ) is the total number of times V1 occurred in the data set. The value “r” is a constant, usually set to one (1).

The metric defined by equation (4) will identify values as being similar if they occur with the same relative frequency for all classifications. The term C1i/C1 represents the likelihood that the central residue will be classified as i given that the feature in question has value V1. Thus, two values are similar if they give DOCKET NO. US020461 PATENT similar likelihoods for all possible classifications. Equation (4) computes overall similarity between two values by finding the sum of differences of these likelihoods over all classifications. The distance between two television programs is the sum of the distances between corresponding feature values of the two television program vectors.

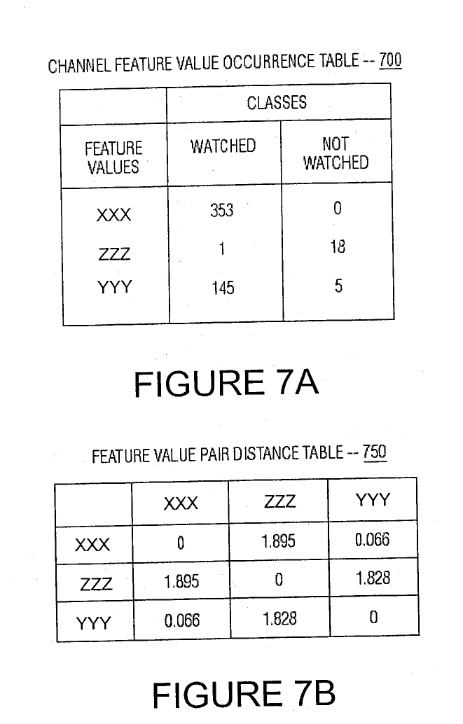

FIG. 7A is a portion of a distance table for the feature values associated with the feature “channel.” The data within FIG. 7A represents or programs the number of occurrences of each channel feature value for each class. The values shown in FIG. 7A have been taken from an exemplary third party viewing history 130.

FIG. 7B displays the distances between each feature value pair computed from the exemplary counts shown in FIG. 7A using the MVDM equation (4). Intuitively, XXX and YYY should be “close” to one another since they occur mostly in the class watched and do not occur (YYY has a small not-watched component) in the class not-watched. FIG. 7B confirms this intuition with a small (non-zero) distance between XXX and YYY. Image feature ZZZ, on the other hand, occurs mostly in the class not-watched and hence should be “distant” to both XXX and YYY, for this data set. FIG. 7B programs the distance between XXX and ZZZ to be 1.895, out of a maximum possible distance of 2.0. Similarly, the distance between YYY and ZZZ is high with a value of 1.828.

Thus, as shown in FIG. 6, the distance computation routine 600 initially identifies programs in the third party viewing history 130 during step 610. For the current program under consideration, the distance computation routine 600 uses equation (4) to compute the distance of each symbolic feature value during step 620 to the corresponding feature of each cluster mean (determined by the mean computation routine 500).

The distance between the current program and the cluster mean is computed during step 630 by aggregating the distances between corresponding features values. A test is performed during step 640 to determine if there are additional programs in the third party viewing history 130 to be considered. If it is determined during step 640 that there are additional programs in the third party viewing history 130 to be considered, then the next program is identified during step 650 and program control proceeds to step 620 and continues in the manner described above.

If, however, it is determined during step 640 that there are no additional programs in the third party viewing history 130 to be considered, then program control returns to the clustering routine 400.

As previously discussed, the mean of a cluster may be characterized using a number of feature values for each possible feature (whether in a feature-based or program-based implementation). The results from multiple means are then pooled by a variation of the distance computation routine 600 to arrive at a consensus decision through voting. For example, the distance is now computed during step 620 between a given feature value of a program and each of the corresponding feature values for the various means. The minimum distance results are pooled and used for voting, e.g., by employing majority voting or a mixture of experts so as to arrive at a consensus decision. For a more detailed discussion of such techniques, see, for example, J. Kittler et al., “Combing Classifiers,” in Proc. of the 13th Int'l Conf. on Pattern Recognition, Vol. II, 897-901, Vienna, Austria, (1996).

As previously indicated, the clustering routine 400 calls a clustering performance assessment routine 800, shown in FIG. 8, to determine when the stopping criteria for creating clusters has been satisfied. The exemplary clustering routine 400 employs a dynamic value of k, with the condition that a stable k has been reached when further clustering of example data does not yield any improvement in the classification accuracy. In addition, the cluster size can be incremented to the point where an empty cluster is recorded. Thus, clustering stops when a natural level of clusters has been reached.

The exemplary clustering performance assessment routine 800 uses a subset of programs from the third party viewing history 130 (the test data set) to test the classification accuracy of the clustering routine 400. For each program in the test set, the clustering performance assessment routine 800 determines the cluster closest to it (which cluster mean is the nearest) and compares the class labels for the cluster and the program under consideration. The percentage of matched class labels translates to the accuracy of the clustering routine 400.

Thus, as shown in FIG. 8, the clustering performance assessment routine 800 initially collects a subset of the programs from the third party viewing history 130 during step 810 to serve as the test data set. Thereafter, a class label is assigned to each cluster during step 820 based on the percentage of programs in the cluster that are watched and not watched. For example, if most of the programs in a cluster are watched, the cluster may be assigned a label of “watched.”

The cluster closest to each program in the test set is identified during step 830 and the class label for the assigned cluster is compared to whether or not the program was actually watched. In an implementation where multiple programs are used to represent the mean of a cluster, an average distance (to each program) or a voting scheme may be employed. The percentage of matched class labels is determined during step 840 before program control returns to the clustering routine 400. The clustering routine 400 will terminate if the classification accuracy has reached a predefined threshold.

The present invention allows clustering of viewing preferences in a manner building stereotypical profiles based directly on image content, alone or in combination with descriptive information regarding the program. The performance of clustering is therefore not limited by the richness of the vocabulary for the descriptive information regarding programs that are the subject of the viewing history. Once the stereotypical profiles are generated, then a profile representing the larger population's viewing interests may be employed to jump-start a recommendation tool for an individual initially lacking sufficient viewing history for accurate recommendations.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system for initializing a program recommendation tool comprising:
a controller employing one or more stereotypical profiles derived from third party viewing histories,
wherein the third party viewing histories include, for each program represented therein, program content values extracted directly from program content for the respective program, and
wherein the stereotypical profiles are derived at least partially based upon the program content values.

2. The system according to claim 1, wherein the program content values comprise one or more of a mean, a standard deviation, and an entropy of image content for a program.

3. The system according to claim 1, wherein the program content values comprise one or more of key frames for a program and a mean, a standard deviation, and an entropy of image content within the key frames.

4. The system according to claim 1, wherein the program content values comprise one or more of:
an advertisement for a program;
a trailer for a program;
a mean, a standard deviation, and an entropy of image content within the advertisement; and
a mean, a standard deviation, and an entropy of image content within the trailer.

5. The system according to claim 1, wherein the controller derives the one or more stereotypical profiles derived from third party viewing histories based at least partially upon the program content values.

6. The system according to claim 1, wherein the controller employs the one or more stereotypical profiles to initialize the program recommendation tool.

7. The system according to claim 1, wherein the one or more stereotypical profiles are derived based upon the program content values and program descriptive data relating to the program.

8. A method for initializing a program recommendation tool comprising:
employing one or more stereotypical profiles derived from third party viewing histories,
wherein the third party viewing histories include, for each program represented therein, program content values extracted directly from program content for the respective program, and
wherein the stereotypical profiles are derived at least partially based upon the program content values.

9. The method according to claim 8, wherein the program content values comprise one or more of a mean, a standard deviation, and an entropy of image content for a program.

10. The method according to claim 8, wherein the program content values comprise one or more of key frames for a program and a mean, a standard deviation, and an entropy of image content within the key frames.

11. The method according to claim 8, wherein the program content values comprise one or more of:
an advertisement for a program;
a trailer for a program;
a mean, a standard deviation, and an entropy of image content within the advertisement; and
a mean, a standard deviation, and an entropy of image content within the trailer.

12. The method according to claim 8, further comprising:
deriving the one or more stereotypical profiles derived from third party viewing histories based at least partially upon the program content values.

13. The method according to claim 8, further comprising:
employing the one or more stereotypical profiles to initialize the program recommendation tool.

14. The method according to claim 8, wherein the one or more stereotypical profiles are derived based upon the program content values and program descriptive data relating to the program.

15. A data signal for initializing a program recommendation tool comprising:
one or more stereotypical profiles derived from third party viewing histories,
wherein the third party viewing histories include, for each program represented therein, program content values extracted directly from program content for the respective program, and
wherein the stereotypical profiles are derived at least partially based upon the program content values.

16. The data signal according to claim 15, wherein the program content values comprise one or more of a mean, a standard deviation, and an entropy of image content for a program.

17. The data signal according to claim 15, wherein the program content values comprise one or more of key frames for a program and a mean, a standard deviation, and an entropy of image content within the key frames.

18. The data signal according to claim 15, wherein the program content values comprise one or more of:
an advertisement for a program;
a trailer for a program;
a mean, a standard deviation, and an entropy of image content within the advertisement; and
a mean, a standard deviation, and an entropy of image content within the trailer.

19. The data signal according to claim 15, wherein the one or more stereotypical profiles are contained within a storage medium accessible to a recommendation tool.

20. The data system according to claim 15, wherein the one or more stereotypical profiles are derived based upon the program content values and program descriptive data relating to the program.
